(19) United States
(12) Patent Application Publication
(10) Pub. No.: US 2005/0099744 A1
(43) Pub. Date: May 12, 2005

(54) Semiconductor integrated circuit

(76) Inventor: Nobutaka Kitagawa, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/798,402

(22) Filed: Mar. 12, 2004

(30) Foreign Application Priority Data
Nov. 10, 2003 (JP) 2003-379993

(51) Int. Cl. H02H 9/00

(52) U.S. Cl. 361/56

(57) ABSTRACT

There is disclosed an inner circuit constituted of a high voltage-proof circuit section and a low voltage-proof circuit section. A usual protective circuit against a surge is directly connected to an external terminal of an IC outside the inner circuit. The high voltage-proof circuit section includes a MOS transistor driven by a power voltage VDD. The low voltage-proof circuit section includes a MOS transistor driven by a power voltage Vdd lower than the power voltage VDD. The protective circuit against the surge is individually connected to the MOS transistor driven by the power voltage Vdd. A capacitor, diode, and the like are used as the protective circuit.

### CROSS-REFERENCE TO RELATED APPLICATIONS

This application is based upon and claims the benefit of priority from prior Japanese Patent Application No. 2003-379993, filed Nov. 10, 2003, the entire contents of which are incorporated herein by reference.

### BACKGROUND OF THE INVENTION

1. Field of the Invention

The present invention relates to a protective circuit against an electrostatic discharge (ESD) destruction of a semiconductor integrated circuit, particularly to a semiconductor integrated circuit on which a thick-film type MOS transistor driven by a high voltage and a thin-film type MOS transistor driven by a low voltage are mounted in a mixed manner.

2. Description of the Related Art

Electrostatic discharges (ESD) from human bodies or machines are great enemies to semiconductor integrated circuits. The ESD forms a surge, enters the semiconductor integrated circuit from the outside, and adversely affects an inner circuit. In a worst case, the inner circuit is destroyed in an unrecoverable state. To prevent this situation, an ESD protective circuit is usually added to the semiconductor integrated circuit.

Examples of incoming paths of the surges by ESD include external terminals of the semiconductor integrated circuit, such as I/O pins and power supply (VDD, VSS) pins. Therefore, the ESD protective circuit is directly connected to the external terminals, when mounted.

As the examples of the ESD protective circuit, the circuits described in Patent Documents 1 to 6 are known, and a typical ESD protective circuit will hereinafter briefly be described.

FIG. 1 shows an example of the ESD protective circuit with respect to the I/O pins.

Data is inputted into the semiconductor integrated circuit from the outside via a path of an I/O pin P1→input/output circuit 11→inner circuit 12. The data is outputted to the outside from the inside of the semiconductor integrated circuit via a path of the inner circuit 12→the input/output circuit 11→the I/O pin P1. An ESD protective circuit 10 is connected between the I/O pin P1 and the input/output circuit 11.

Power potentials VDD, VSS inputted via the power supply (VDD, VSS) pins P2, P3 are supplied to the ESD protective circuit 10, input/output circuit 11, and inner circuit 12.

If the surge by ESD is inputted into the circuit via the I/O pin P1, the surge is momentarily absorbed by the ESD protective circuit. Therefore, the surge is not directly supplied to the input/output circuit 11 and inner circuit 12. As a result, the input/output circuit 11 and inner circuit 12 can be protected.

Additionally, in this case, it is assumed that the surge by ESD is inputted via the I/O pin P1, but the surge by ESD is also inputted via another external terminal, that is, the power supply (VDD, VSS) pins P2, P3. Therefore, a system in which the inner circuit 12 is protectable needs to be constructed against the surges inputted via the power supply (VDD, VSS) pins P2, P3.

FIG. 2 shows an example of the ESD protective circuit against the power supply (VDD, VSS) pins.

The data is inputted/outputted with respect to the semiconductor integrated circuit via the I/O pin P1. Since a connection relation among an ESD protective circuit 10A and the input/output circuit 11 and the inner circuit 12 is the same as that of FIG. 1, the description is omitted here.

The power potentials VDD, VSS inputted via the power supply (VDD, VSS) pins P2, P3 are supplied to the ESD protective circuit 10A, input/output circuit 11, and inner circuit 12. In consideration of a case where the surges are inputted into the power supply (VDD, VSS) pins P2, P3, the power supply (VDD, VSS) pins P2, P3 are connected to ESD protective circuits 10B, 10C.

For example, the ESD protective circuit 10A is constituted, for example, of a portion which absorbs an excessive voltage (surge) having a positive value and a portion which absorbs an excessive voltage (surge) having a negative value. On the other hand, for example, the ESD protective circuit 10B is constituted only of the portion which absorbs the excessive voltage (surge) having the positive value, and the ESD protective circuit 10C is constituted only of the portion which absorbs the excessive voltage (surge) having the negative value.

It is to be noted that polarities of the power potentials VDD, VSS are different from each other, or one of the potentials is a ground potential VGND. The polarity of the power potential VDD is usually positive, and the power potential VSS is the ground potential VGND.

If the surge having the positive value is inputted via the VDD pin P2 in this circuit, this surge is momentarily absorbed by the ESD protective circuit 10B. Therefore, the surges are not directly supplied to the input/output circuit 11 and inner circuit 12. As a result, the input/output circuit 11 and inner circuit 12 can be protected.

Moreover, assuming that the surge having the negative value is inputted via the VSS pin P3, the surge is momentarily absorbed by the ESD protective circuit 10C. Therefore, the surge is not directly supplied to the input/output circuit 11 and inner circuit 12 in the same manner as described above. As a result, the input/output circuit 11 and inner circuit 12 can be protected.

Here, for example, a semiconductor integrated circuit of a single power voltage type is considered in which one type of power potential is supplied to a chip (ground potential is not counted in). The MOS transistor for use in the inner circuit of the semiconductor integrated circuit usually has a gate oxide film which is sufficiently thick to be bearable even against the single power voltage VDD (=VDD−VSS (0 V)). That is, a gate proof voltage of the MOS transistor is set to a predetermined value which exceeds the single power voltage VDD.

Moreover, the ESD protective circuit is disposed to clamp the voltage applied to the gate oxide film of the MOS transistor on the predetermined value which is not more than the gate proof voltage and to protect the MOS transistor, when the voltage (surge) exceeding the gate proof voltage of the MOS transistor is applied to the external terminal.

However, in recent years, functions of the semiconductor integrated circuit have been multiplied. There has increasingly been a case where a thin-film type MOS transistor driven by an inner power voltage Vdd which is obtained by lowering the single power voltage VDD and whose value is smaller than the single power voltage VDD is used in addition to a thick-film type MOS transistor having a gate proof voltage capable of sufficiently withstanding the single power voltage VDD in one chip (semiconductor integrated circuit).

For example, as shown in FIG. 3, the inner circuit 12 is constituted of a high voltage-proof circuit section 13 and low voltage-proof circuit section 15, the power potential (VDD, VSS) is supplied to the high voltage-proof circuit section 13, and a power potential (Vdd, VSS) produced by a step-down circuit 14 is supplied to a low voltage-proof circuit section 15. Moreover, the thick-film type MOS transistor in the high voltage-proof circuit section 13 is driven by the power potential (VDD, VSS), and the thin-film type MOS transistor in the low voltage-proof circuit section 15 is driven by the power potential (Vdd, VSS).

Here, the thin-film type MOS transistor has only a gate proof voltage smaller than the power voltage VDD. However, for example, the step-down circuit 14 is disposed in the semiconductor integrated circuit, the step-down circuit 14 is used to produce the inner power potential Vdd (<VDD) from the power potential VDD, and the thin-film type MOS transistor is driven by the inner power potential Vdd. Then, a sufficiently usual operation can be carried out.

In this manner, for example, when a part of the inner circuit 12 is constituted of the low voltage-proof circuit section 15 constituted of the thin-film type MOS transistor, an operation rate of the inner circuit 12 can be enhanced.

However, the ESD protective circuit for protecting the inner circuit from the surge by ESD has not heretofore sufficiently be studied with respect to the semiconductor integrated circuit on which the thick-film type MOS transistor and thin-film type MOS transistor are mounted in a mixed manner.

That is, if the surge by ESD is inputted into the external terminal in the semiconductor integrated circuit, the thick-film type MOS transistor can be protected by the ESD protective circuit of a conventional type (FIGS. 1 and 2). However, for example, as shown in FIG. 4, for the thin-film type MOS transistor, there is has a problem that the voltage exceeding the gate proof voltage is sometimes applied to the gate oxide film and a low voltage circuit section is destroyed.

In this manner, in recent years, especially in the semiconductor integrated circuit of the single power voltage type, all the inner circuits cannot sometimes be protected only by the absorption of the surges by the protective circuit in a part directly connected to the external terminals such as power terminals, and measures against this problem need to be studied.

### BRIEF SUMMARY OF THE INVENTION

According to an aspect of the present invention, there is provided a semiconductor integrated circuit comprising: an inner circuit driven by a single power voltage; and a first protective circuit which protects the inner circuit from a surge. The inner circuit includes: a high voltage-proof circuit section constituted of a first MOS transistor; a low voltage-proof circuit section constituted of a second MOS transistor having a gate insulating film thinner than that of the first MOS transistor; and a second protective circuit directly connected to the low voltage-proof circuit section to protect the second MOS transistor from the surge.

### BRIEF DESCRIPTION OF THE SEVERAL VIEWS OF THE DRAWING

FIG. 1 is a diagram showing a conventional protective circuit;

FIG. 2 is a diagram showing a conventional protective circuit;

FIG. 3 is a diagram showing an example of an inner circuit of a semiconductor integrated circuit;

FIG. 4 is a diagram showing clamp characteristics of the conventional protective circuit;

FIG. 5 is a diagram schematically showing an ESD protective circuit according to a first example of the present invention;

FIG. 6 is a diagram schematically showing the ESD protective circuit according to a second example of the present invention;

FIG. 7 is a diagram schematically showing the ESD protective circuit according to a third example of the present invention;

FIG. 8 is a diagram showing a relation between a range of an operation voltage and a clamp voltage;

FIG. 9 is a diagram showing a relation between the clamp voltage and a current;

FIG. 10 is a diagram showing an application example into a PLL circuit;

FIG. 11 is a diagram showing a level shifter to which the present invention is applicable;

FIG. 12 is a diagram showing the ESD protective circuit according to a first embodiment;

FIG. 13 is a diagram showing the ESD protective circuit according to the first embodiment;

FIG. 14 is a diagram showing the ESD protective circuit according to a second embodiment;

FIG. 15 is a diagram showing the ESD protective circuit according to the second embodiment;

FIG. 16 is a diagram showing the clamp characteristics of the protective circuit according to the second embodiment;

FIG. 17 is a diagram showing the ESD protective circuit according to a third embodiment;

FIG. 18 is a diagram showing the ESD protective circuit according to the third embodiment;

FIG. 19 is a diagram showing an example of a test circuit with respect to ESD; and

FIG. 20 is a diagram showing an application example of the ESD protective circuit according to the example of the present invention.

### DETAILED DESCRIPTION OF THE INVENTION

A semiconductor integrated circuit of an aspect of the present invention will be described below in detail with reference to the accompanying drawing.

1. Whole Constitution

(1) First Example

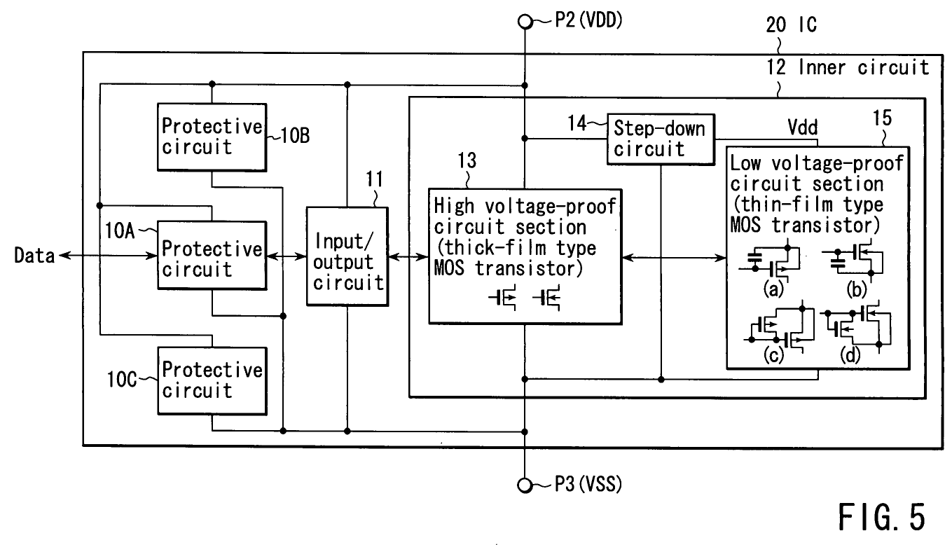

FIG. 5 shows an ESD protective circuit according to a first example of the present invention.

In the ESD protective circuit of the first example, an inner circuit 12 is constituted of a high voltage-proof circuit section 13 and low voltage-proof circuit section 15, and an object is a semiconductor integrated circuit (IC) 20 of a single power voltage type in which one type of power potential VDD (ground potential is not counted in) is supplied to a chip.

The high voltage-proof circuit section 13 is constituted of a thick-film type MOS transistor including a gate oxide film having such a thickness that the film can sufficiently withstand even the power voltage VDD (=VDD (e.g., 3.3 V)−VSS (0 V)). A gate proof voltage of the thick-film type MOS transistor is set to a value (e.g., 12 V) higher than that of the power voltage VDD.

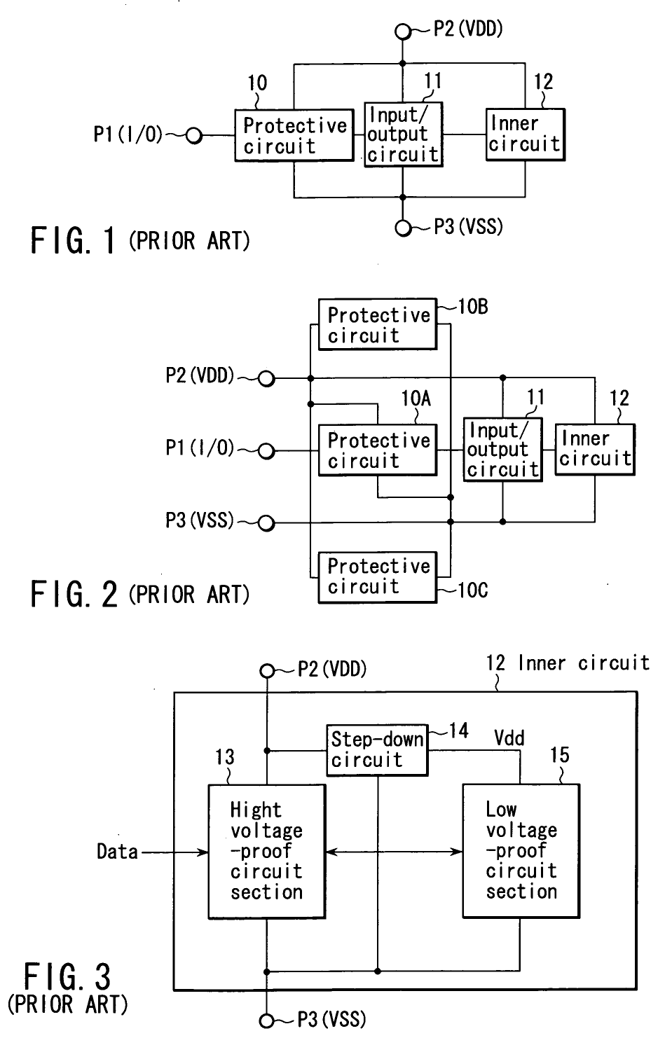

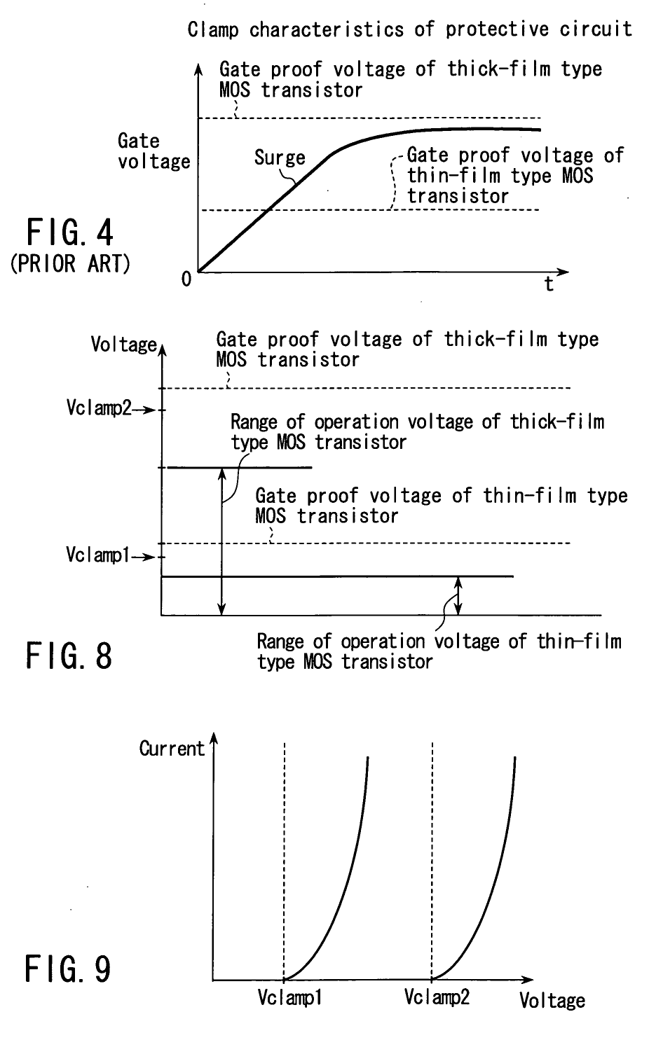

ESD protective circuits 10A, 10B, 10C protect the thick-film type MOS transistors in an input/output circuit 11 and the high voltage-proof circuit section 13. It is to be noted that the inner circuit 12 of FIG. 5 corresponds to that in FIGS. 1 and 2.

The low voltage-proof circuit section 15 is constituted of a thin-film type MOS transistor including a gate oxide film having such a thickness that the film can sufficiently withstand even an inner power voltage Vdd (=Vdd (e.g., 1.5 V)−VSS (0 V)) produced by a step-down circuit 14. The gate proof voltage of the thin-film type MOS transistor is set to a value (e.g., 4 V) higher than the inner power voltage Vdd, but this value is smaller than the gate proof voltage of the thick-film type MOS transistor.

The ESD protective circuit of the first example is individually added to the thin-film type MOS transistor in order to protect the thin-film type MOS transistor constituting the low voltage-proof circuit section 15.

For example, the ESD protective circuit is constituted of a capacitor, and the capacitor is connected between a source/bulk and gate of the MOS transistor. Accordingly, when the voltage by the surge (pulse) is applied between the source/bulk and gate of the MOS transistor, both electrodes (source/bulk and gate) are forcibly short-circuited, and therefore the MOS transistor can be prevented from being destroyed ((a) and (b)).

Moreover, for example, the ESD protective circuit is constituted of a diode, and the diode is connected between the source/bulk and gate of the MOS transistor. Accordingly, even when the voltage by the surge (pulse) is applied between the source/bulk and gate of the MOS transistor, the voltage between the electrodes (source/bulk and gate) does not rise to be not less than a predetermined value, and therefore the MOS transistor can be prevented from being destroyed ((c) and (d)).

It is to be noted that the step-down circuit 14 may also be replaced with a simple device or circuit which applies a limiter to an upper limit of the potential of an intermediate node between a power terminal and ground terminal.

For example, with a circuit (level shifter) shown in FIG. 11, since the MOS transistor has a function of lowering the voltage, the thick-film type MOS transistor and thin-film type MOS transistor are mounted in a mixed manner.

Moreover, for the diode, in addition to the diode-connected MOS transistor as shown, a diode device may be used as such.

The ESD protective circuit may be connected to a thin-film type MOS transistor in which the gate is easily destroyed by the surge in the low voltage-proof circuit section 15, such as a MOS transistor which directly receives the inner power voltage Vdd and a MOS transistor which directly participates in exchange of data with respect to the high voltage-proof circuit section 13.

Additionally, some of the thin-film type MOS transistors constituting the low voltage-proof circuit section 15 are easily influenced by the surge by ESD, and the others are not easily influenced. For example, there is also a MOS transistor in which the rise of the gate voltage does not occur even in a surge applied state. A degree of the influence by the surge depends on the constitution of the inner circuit (logic), the constitution of logic which controls initialization such as reset, and the like.

Therefore, the MOS transistor easily influenced by the surge by ESD is verified and specified beforehand. When the ESD protective circuit of the example of the present invention is applied only to the MOS transistor, a demerit in a circuit size can be minimized.

In this manner, for the example of the present invention, in addition to the ESD protective circuits 10A, 10B, 10C for directly absorbing the surges inputted via the external terminals such as I/O pins and power pins as shown in FIGS. 1 and 2, an ESD protective circuit for individually protecting the thin-film type MOS transistors is newly disposed. Characteristics of the ESD protective circuit for individually protecting the thin-film type MOS transistors are individually set in consideration of the gate proof voltage of the MOS transistor, and the like.

Accordingly, even with the input of the surge which cannot be prevented by the ESD protective circuits 10A, 10B, 10C and which influences the thin-film type MOS transistor, the thin-film transistors can individually be protected by the use of the protective circuit in the example of the present invention, and a resistance to ESD of the semiconductor integrated circuit can be improved.

(2) Second Example

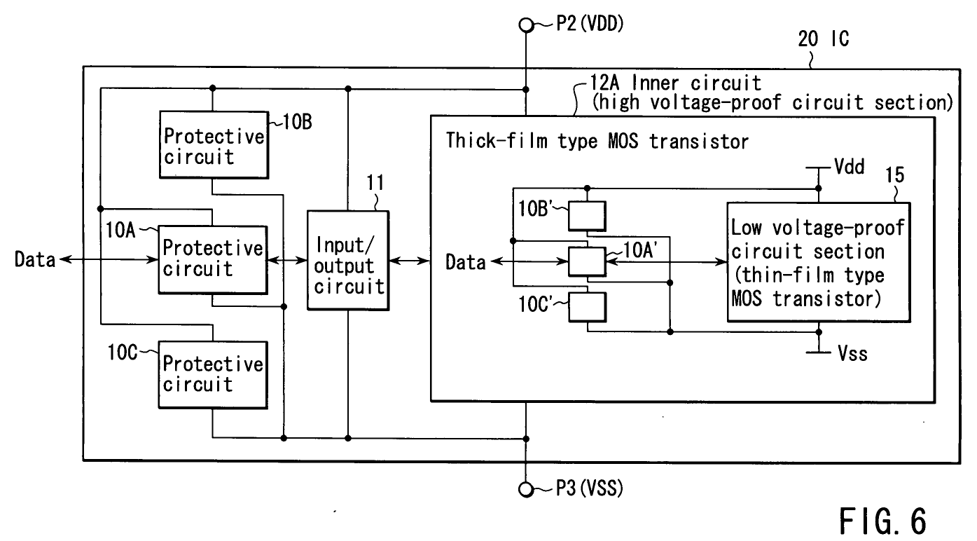

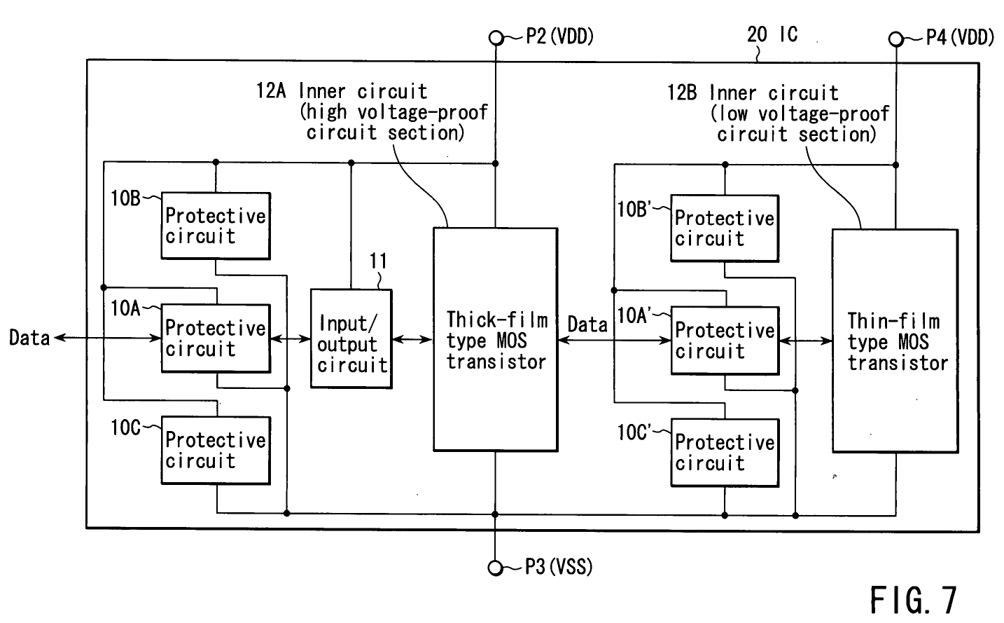

FIG. 6 shows the ESD protective circuit according to a second example of the present invention.

The second example is a modification of the first example. The second example is characterized in that the low voltage-proof circuit section (thin-film type MOS transistor) 15 and ESD protective circuits 10A′, 10B′, 10C′ for the low voltage-proof circuit section 15 are arranged in an inner circuit (high voltage-proof circuit section) 12A.

The inner power potential Vdd may also be produced by the step-down circuit formed in the inner circuit 12A, or may also be produced using the device or circuit which applies the limiter to the upper limit of the potential of the intermediate node between the power terminal and the ground terminal.

The protection object by the ESD protective circuits 10A, 10B, 10C is the thick-film type MOS transistor in the inner circuit 12A. On the other hand, the protection object by the ESD protective circuits 10A′, 10B′, 10C′ is the thin-film type MOS transistor in the low voltage-proof circuit section 15.

Here, there is an idea that the functions of the ESD protective circuits 10A′, 10B′, 10C′ are also added to the ESD protective circuits 10A, 10B, 10C and the ESD protective circuits 10A′, 10B′, 10C′ are omitted, but this is impossible.

Because for the addition of the functions of the ESD protective circuits 10A′, 10B′, 10C′ to the ESD protective circuits 10A, 10B, 10C, as shown in FIG. 8, a clamp voltage Vclamp2 of the ESD protective circuits 10A, 10B, 10C needs to be lowered to a clamp voltage Vclamp1 of the ESD protective circuits 10A′, 10B′, 10C′. However, the clamp voltage Vclamp1 is included in a range of the operation voltage of the thick-film type MOS transistor. As a result, this idea cannot be realized.

It is to be noted that the clamp voltages Vclamp1, Vclamp2 indicate potentials at which the current starts to flow through the ESD protective circuit as shown in FIG. 9, and the voltage exceeding the clamp voltages Vclamp1, Vclamp2 is not produced in the inner circuit 12A.

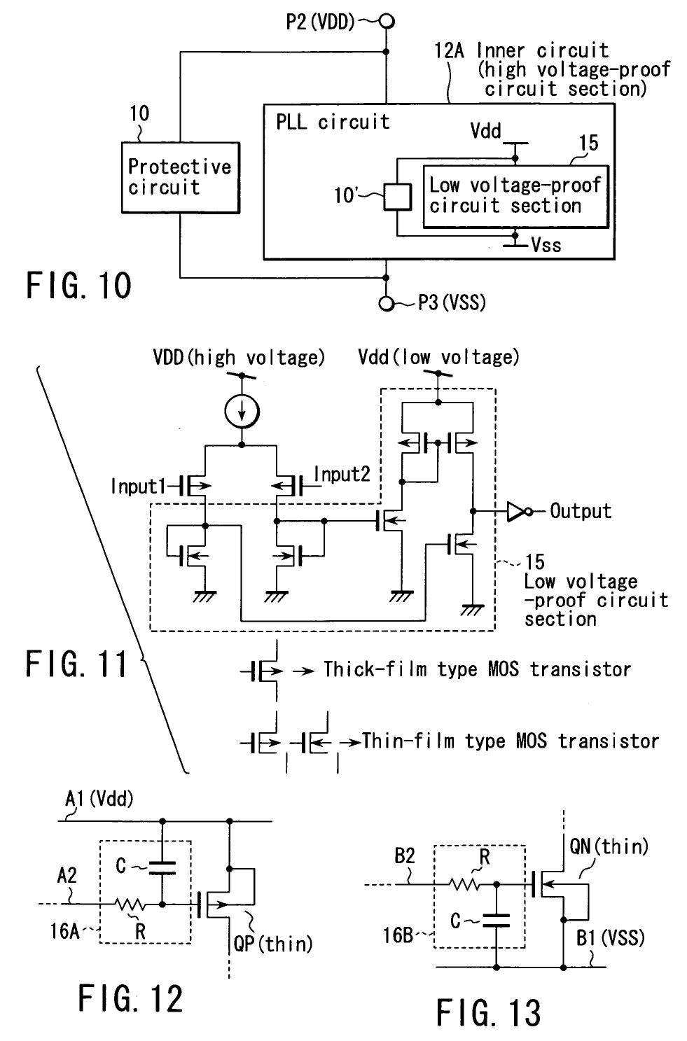

Concrete examples of the inner circuit 12A of the second example includes a PLL circuit shown in FIG. 10. For the PLL circuit, since a part of the inner circuit 12A is constituted of the low voltage-proof circuit section 15, the operation of the PLL circuit can be speeded up.

(3) Third Example

FIG. 13 shows the ESD protective circuit according to a third example of the present invention.

The object of the ESD protective circuit of the third example is a plural power voltage (two power voltage in the present example) type semiconductor integrated circuit (IC) 20.

The example of the present invention is effective for the above-described semiconductor integrated circuit of the single power voltage type, but can also be applied to the following semiconductor integrated circuit of the plural power voltage type.

The inner circuit (high voltage-proof circuit section) 12A and inner circuit (low voltage-proof circuit section) 12B are arranged in the semiconductor integrated circuit 20. The inner circuits 12A, 12B are in a relation in which data is mutually and directly exchanged.

The power voltage VDD (=VDD (e.g., 3.3 V)−VSS (0 V)) is supplied to the inner circuit (high voltage-proof circuit section) 12A. The inner circuit 12A is constituted of the thick-film type MOS transistor including the gate oxide film having such a thickness that the film can sufficiently withstand even the power voltage VDD. The gate proof voltage of the thick-film type MOS transistor is set to be higher (e.g., 12 V) than the power voltage VDD.

The ESD protective circuits 10A, 10B, 10C protect the respective thick-film type MOS transistors in the input/output circuit 11 and the inner circuit (high voltage-proof circuit section) 12A.

The power voltage Vdd (=Vdd (e.g., 1.5 V)−VSS (0 V)) is supplied to the inner circuit (low voltage-proof circuit section) 12B. The inner circuit 12B is constituted of the thin-film type MOS transistor including the gate oxide film having such a thickness that the film can sufficiently withstand even the power voltage Vdd. The gate proof voltage of the thin-film type MOS transistor is set to be higher (e.g., 4 V) than the power voltage Vdd.

The ESD protective circuits 10A′, 10B′, 10C′ protect the thin-film type MOS transistor in the inner circuit (low voltage-proof circuit section) 12B.

The ESD protective circuits 10A′, 10B′, 10C′ may protect the whole inner circuit 12B, or may individually protect the thin-film type MOS transistors in the inner circuit 12B. In the latter case, the transistors are divided into transistors requiring the protection and those which do not require any protection in the same manner as in the first and second examples, and the transistors requiring the protection is directly connected to the ESD protective circuits 10A′, 10B′, 10C′.

In this manner, in the example of the present invention, the ESD protective circuits 10A′, 10B′, 10C′ for protecting the thin-film type MOS transistor are newly arranged in addition to the ESD protective circuits 10A, 10B, 10C for directly absorbing the surge inputted via the external terminals such as the I/O pin and power pin. The characteristics of the ESD protective circuits 10A′, 10B′, 10C′ for protecting the thin-film type MOS transistor are set in consideration of the gate proof voltage of the MOS transistor.

Accordingly, even with the input of the surge which influences the thin-film type MOS transistor, the thin-film type MOS transistor can be protected by the use of the ESD protective circuits 10A′, 10B′, 10C′ of the example of the present invention, and the resistance to ESD of the semiconductor integrated circuit can be enhanced.

(4) Others

Table 1 shows an application range of the present invention.

TABLE 1

| | Single power | Plural power |
|---|---|---|
| | supply | supplies |
| Thick-film | Protect by | Protect by |
| type | protective circuit | protective circuit |
| MOS | of conventional | of conventional |
| transistor | type | type |
| Thin-film | Protect by | Protect by |
| type | protective circuit | protective circuit |
| MOS | of the present | of conventional |
| transistor | invention | type or the present |
| | | invention |

The example of the present invention is most effective for the protection of the thin-film type MOS transistor in the IC chip receiving the single power potential (first and second examples). It is to be noted that the thick-film type MOS transistor in the IC chip receiving single power potential can be protected by a conventional protective circuit.

The thick-film type MOS transistor in the IC chip receiving a plurality of power potentials can be protected by the conventional protective circuit. The thin-film type MOS transistor in the IC chip receiving the plurality of power potentials can be protected by the application of the example of the present invention as shown in the third example.

2. Embodiment

Embodiments of the ESD protective circuit according to the examples of the present invention will hereinafter be described.

(1) First Embodiment

A first embodiment is an example of connection of a so-called resistance (R) capacitor (C) type ESD protective circuit to the MOS transistor of the low voltage-proof circuit section.

FIG. 12 shows an example of the ESD protective circuit for a thin-film type P channel MOS transistor.

The source and bulk (e.g., N well) of a P channel MOS transistor QP(thin) are connected to a Vdd node A1 to which the inner power potential Vdd is applied. The drain of the MOS transistor QP(thin) is connected, for example, to another MOS transistor. The gate of the MOS transistor QP(thin) is connected to a protective circuit 16A.

The protective circuit 16A is constituted of a resistance R and capacitor C. The capacitor C is connected between the Vdd node A1 and the gate of the MOS transistor QP(thin). The resistance R is connected between an inner node A2 and the gate of the MOS transistor QP(thin).

In this circuit, a high voltage can be prevented from being applied between the gate and the source of the MOS transistor QP(thin) by a certain time constant of the protective circuit 16A even in a situation in which the high voltage is applied between the gate and source of the MOS transistor QP(thin), for example, because of the surge by ESD. Therefore, the gate oxide film of the MOS transistor QP(thin) can be prevented from being destroyed.

FIG. 13 shows the example of the ESD protective circuit for a thin-film type N channel MOS transistor.

The source and bulk (e.g., P well) of an N channel MOS transistor QN(thin) are connected to a VSS node B1 to which the power potential (e.g., the ground potential) VSS is applied. The drain of the MOS transistor QN(thin) is connected, for example, to another MOS transistor. The gate of the MOS transistor QN(thin) is connected to a protective circuit 16B.

The protective circuit 16B is constituted of the resistance R and capacitor C. The capacitor C is connected between the VSS node B1 and the gate of the MOS transistor QN(thin). The resistance R is connected between an inner node B2 and the gate of the MOS transistor QN(thin).

In this circuit, the high voltage can be prevented from being applied between the gate and the source of the MOS transistor QN(thin) by the certain time constant of the protective circuit 16B even in the situation in which the high voltage is applied between the gate and source of the MOS transistor QN(thin), for example, because of the surge by ESD. Therefore, the gate oxide film of the MOS transistor QN(thin) can be prevented from being destroyed.

Here, the time constant of the protective circuit in FIGS. 12 and 13 is set as follows in order to prohibit transmission to the MOS transistors QP(thin), QN(thin) only with respect to an unnecessary high voltage because of the surge.
Transition time T1 of signal>time constant τ>ESD application time T2 (1)

The transition time T1 of the signal indicates a time from when levels of the signals inputted into the MOS transistors QP(thin), QN(thin) change until the levels change next. The ESD application time T2 is a period (width of a surge pulse) in which the surge is supplied to the semiconductor integrated circuit.

Standards of the ESD property are usually strictly determined with respect to the semiconductor integrated circuit, and it is tested whether or not this standard is satisfied before shipment of products. That is, safety against a certain surge is assured with respect to the product which has cleared the test.

The test is executed, for example, using a test circuit shown in FIG. 19, and a surge, for example, of about 150 ns (=1.5 kΩ×100 pF) is produced in a human body model (HBM).

For example, this value of about 150 ns is used as the ESD application time T2. Additionally, the time constant τ of the protective circuit of the present invention is set, for example, to three or more times the ESD application time T2, for example, about 500 ns allowing for a sufficient allowance.

As seen from the above equation (1), a signal rate is raised in the protective circuit according to the first embodiment. When the transition time T1 of the signal is shorter (value of T1 is smaller), the range of the time constant τ is narrowed. Depending on the circumstances, it is also considered that T1<T2, and the range of the time constant τ is eliminated.

Therefore, the protective circuit of the first embodiment is effective especially for the semi-conductor integrated circuit which does not handle a signal transiting at a high rate.

(2) Second Embodiment

A second embodiment is an example of the connection of a so-called diode type ESD protective circuit to the MOS transistor of the low voltage-proof circuit section.

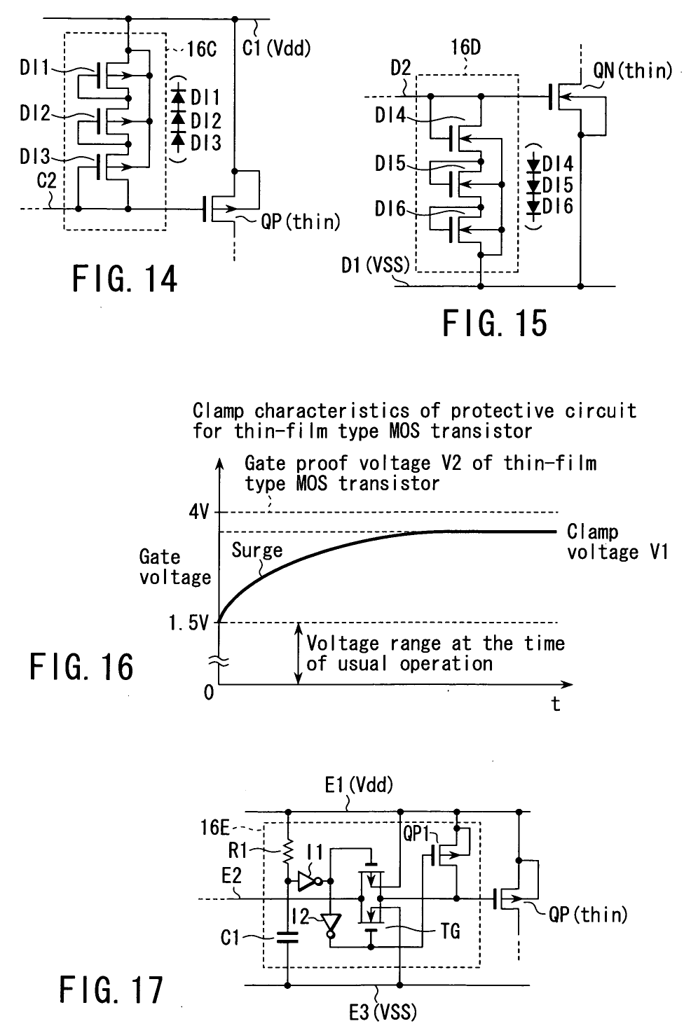

FIG. 14 shows an example of the ESD protective circuit for the thin-film type P channel MOS transistor.

The source and bulk (e.g., N well) of the P channel MOS transistor QP(thin) are connected to a Vdd node C1 to which the inner power potential Vdd is applied. The drain of the MOS transistor QP(thin) is connected, for example, to another MOS transistor. The gate of the MOS transistor QP(thin) is connected to a protective circuit 16C.

The protective circuit 16C is constituted of a plurality of (three in the present example) diodes DI1, DI2, DI3 connected in series between the Vdd node C1 and the gate of the MOS transistor QP(thin).

The diodes DI1, DI2, DI3 are constituted, for example, of a diode-connected P channel MOS transistor. The bulk (e.g., N well) in which the MOS transistor is formed is connected to the Vdd node C1, and the gate and drain of the MOS transistor are connected to each other.

In this circuit, the protective circuit 16C absorbs the high voltage, when the high voltage is applied between the gate and source of the MOS transistor QP(thin), for example, because of the surge by ESD. That is, when the voltage applied between the gate and source of the MOS transistor QP(thin) exceeds a specific value, the current starts to flow through the diodes DI1, DI2, DI3, and therefore the gate oxide film of the MOS transistor QP(thin) can be prevented from being destroyed.

FIG. 15 shows the example of the ESD protective circuit for the thin-film type N channel MOS transistor.

The source and bulk (e.g., P well) of the N channel MOS transistor QN(thin) are connected to a VSS node D1 to which the power potential (e.g., the ground potential) VSS is applied. The drain of the MOS transistor QN(thin) is connected, for example, to another MOS transistor. The gate of the MOS transistor QN(thin) is connected to a protective circuit 16D.

The protective circuit 16D is constituted of a plurality of (three in the present example) diodes DI4, DI5, DI6 connected in series between the VSS node D1 and the gate of the MOS transistor QN(thin).

The diodes DI4, DI5, DI6 are constituted, for example, of a diode-connected N channel MOS transistor. The bulk (e.g., P well) in which the MOS transistor is formed is connected to the VSS node D1, and the gate and drain of the MOS transistor are connected to each other.

In this circuit, the protective circuit 16D absorbs the high voltage, when the high voltage is applied between the gate and source of the MOS transistor QN(thin), for example, because of the surge by ESD. That is, when the voltage applied between the gate and source of the MOS transistor QN(thin) exceeds the specific value, the current starts to flow through the diodes DI4, DI5, DI6, and therefore the gate oxide film of the MOS transistor QN(thin) can be prevented from being destroyed.

Here, in the protective circuits in FIGS. 14 and 15, a maximum voltage applied between the gate and source of the MOS transistor QP(thin), QN(thin) is determined by the number of diodes of the protective circuit 16C, 16D. That is, the voltage applied between the gate and source of the MOS transistor QP(thin), QN(thin) by these diodes cannot exceed the specific value.

This specific value will hereinafter be referred to as the clamp voltage.

FIG. 16 shows the clamp characteristics of the protective circuit of the second embodiment, that is, a relation between the clamp voltage and the gate proof voltage.

In the protective circuit of the second embodiment, in order to achieve the original object, a clamp voltage V1 is set to be lower than a gate proof voltage V2 of the thin-film type MOS transistor which is the object of the protection. On the other hand, the clamp voltage V1 does not have to be larger than the maximum value of a range of the voltage (voltage range at the time of a usual operation) applied to the thin-film type MOS transistor which is the object of the protection at the time of the usual operation in order not to adversely affect the usual operation.

Therefore, the clamp voltage is set in the following range.
Gate proof voltage V2>clamp voltage V1>maximum value of voltage range at the time of usual operation (2)

When the ESD protective circuit of the second embodiment is used in this range, the resistance to the ESD can be enhanced even with a signal changing at a high rate without adversely affecting the usual operation.

(3) Third Embodiment

A third embodiment is an example of the connection of a so-called analog switch type ESD protective circuit to the MOS transistor of the low voltage-proof circuit section.

FIG. 17 shows an example of the ESD protective circuit for the thin-film type P channel MOS transistor.

The source and bulk (e.g., N well) of the P channel MOS transistor QP(thin) are connected to a Vdd node E1 to which the inner power potential Vdd is applied. The drain of the MOS transistor QP(thin) is connected, for example, to another MOS transistor. The gate of the MOS transistor QP(thin) is connected to a protective circuit 16E.

The protective circuit 16E is constituted of a resistance R1, capacitor C1, inverters I1, I2, transfer gate TG, and P channel MOS transistor QP1.

The resistance R1 and capacitor C1 are connected in series between the Vdd node E1 and VSS node E3. A connection node of the resistance R1 and capacitor C1 is connected to the gate of the P channel MOS transistor constituting the transfer gate TG via the inverter I1. The connection node is connected to the gate of the N channel MOS transistor constituting the transfer gate TG via the inverters I1, I2.

The signal is inputted into the gate of the MOS transistor QP(thin) from an inner node E2 via the transfer gate TG. The source/bulk of the MOS transistor QP1 is connected to the Vdd node E1, the drain is connected to the gate of the MOS transistor QP(thin), and the gate is connected to an output end of the inverter I2.

In this circuit, at the time of the usual operation, the output signal of the inverter I1 is “L (=VSS)”, the output signal of the inverter I2 is “H (=Vdd)”, the transfer gate TG is in an on state, and the MOS transistor QP1 is in an off state.

Here, for example, a case where the usual operation is not performed, for example, a case where the surge by ESD is applied at the time of IC delivery before mounting the IC is considered. In this case, if a positive or negative high potential is transmitted to the inner node E2 because of the surge by ESD, E1(Vdd) and E3(VSS) are in a floating state or at 0 V, and therefore the transfer gate TG has the off state. Therefore, the gate oxide film of the MOS transistor QP(thin) can be prevented from being destroyed without transmitting the positive or negative high voltage to the gate of the MOS transistor QP(thin) to be protected.

Moreover, for example, even when the positive or negative high potential is transmitted to the E1(Vdd) and inner node E2 at the time of the IC delivery before mounting the IC because of the surge by ESD, the transfer gate TG has the off state, and therefore the high potential is not transmitted to the gate of the MOS transistor QP(thin) as described above. The P channel MOS transistor QP1 has the on state for a moment determined by the time constant of the resistance R1 and capacitor C1. Therefore, even when the positive or negative high potential is transmitted to E1(Vdd), the gate and source of the MOS transistor QP(thin) are short-circuited, and the high voltage is not applied to the MOS transistor QP(thin) to be protected. Therefore, the gate oxide film of the MOS transistor QP(thin) can be prevented from being destroyed.

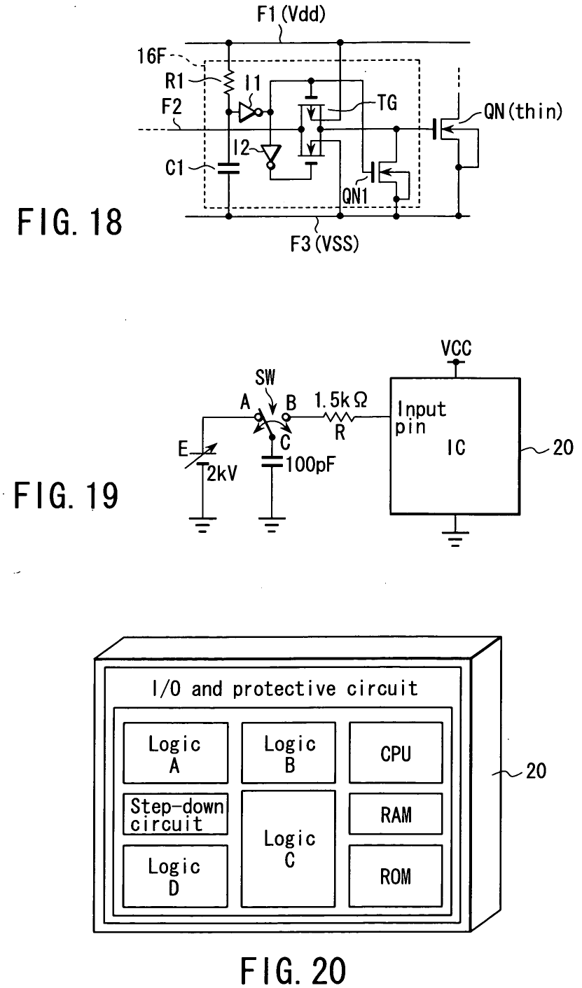

FIG. 18 shows the example of the ESD protective circuit for the thin-film type N channel MOS transistor.

The source and bulk (e.g., P well) of the N channel MOS transistor QN(thin) are connected to a VSS node F3 to which the power potential (e.g., the ground potential) VSS is applied. The drain of the MOS transistor QN(thin) is connected, for example, to another MOS transistor. The gate of the MOS transistor QN(thin) is connected to a protective circuit 16F.

The protective circuit 16F is constituted of the resistance R1, capacitor C1, inverters I1, I2, transfer gate TG, and N channel MOS transistor QN1.

The resistance R1 and capacitor C1 are connected in series between the Vdd node F1 and VSS node F3. The connection node of the resistance R1 and capacitor C1 is connected to the gate of the P channel MOS transistor constituting the transfer gate TG via the inverter I1. The connection node is connected to the gate of the N channel MOS transistor constituting the transfer gate TG via the inverters I1, I2.

The signal is inputted into the gate of the MOS transistor QN(thin) from an inner node F2 via the transfer gate TG. The source/bulk of the MOS transistor QN1 is connected to the VSS node F3, the drain is connected to the gate of the MOS transistor QN(thin), and the gate is connected to the output end of the inverter I1.

In this circuit, at the time of the usual operation, the output signal of the inverter I1 is “L (=VSS)”, the output signal of the inverter I2 is “H (=Vdd)”, the transfer gate TG is in the on state, and the MOS transistor QN1 is in the off state.

Here, for example, the case where the usual operation is not performed, for example, the case where the surge by ESD is applied at the time of IC delivery before mounting the IC is considered. In this case, if the positive or negative high potential is transmitted to the inner node F2 because of the surge by ESD, F1(Vdd) and F3(VSS) are in the floating state or at 0 V, and therefore the transfer gate TG has the off state. Therefore, the gate oxide film of the MOS transistor QN(thin) can be prevented from being destroyed without transmitting the positive or negative high voltage to the gate of the MOS transistor QN(thin) to be protected.

Moreover, for example, even when the positive or negative high potential is transmitted to the F3(VSS) and inner node F2 at the time of the IC delivery before mounting the IC because of the surge by ESD, the transfer gate TG has the off state, and therefore the high potential is not transmitted to the gate of the MOS transistor QN(thin) as described above. The N channel MOS transistor QN1 has the on state for the moment determined by the time constant of the resistance R1 and capacitor C1. Therefore, even when the positive or negative high potential is transmitted to F3(VSS), the gate and source of the MOS transistor QN(thin) are short-circuited, and the high voltage is not applied to the MOS transistor QN(thin) to be protected. Therefore, the gate oxide film of the MOS transistor QN(thin) can be prevented from being destroyed.

In this manner, in the ESD protective circuit according to the third embodiment, for example, when the surge enters a power (Vdd, VSS) node, the gate and source of the thin-film type MOS transistors QP(thin), QN(thin) constituting the object of the protection are thereafter short-circuited only for the specific period, and therefore these MOS transistors can be protected.

For the ESD protective circuit of the third embodiment, different from the ESD protective circuits of the first and second embodiments, conditions concerning the signal rate and clamp voltage are not set. Therefore, the third embodiment is effective especially for the semiconductor integrated circuit which handles the signal transiting at the high rate.

3. Application Example

FIG. 20 shows one example of a layout of the semiconductor integrated circuit to which the ESD protective circuit of the example of the present invention is applied.

A block constituted of I/O and protective circuit is disposed in an edge of the chip 20. The protective circuits herein indicate the protective circuits 10A, 10B, 10C of the conventional type shown in FIGS. 1 and 2. A plurality of function blocks are arranged in a middle part of the chip 20. For example, CPU, RAM, and ROM indicate function blocks.

Furthermore, logic circuits A, B, C, D are arranged as the function blocks in the chip 20. The logic circuits A, B, C are drive, for example, by the power potentials VDD, VSS. On the other hand, the logic circuit D is driven, for example, by the power potential Vdd (<VDD), VSS.

The ESD protective circuit of the example of the present invention is applied at least one or all of the MOS transistors constituting the logic circuit D.

4. Others

The ESD protective circuit of the example of the present invention is effective for the semiconductor integrated circuit including a plurality of MOS transistors having different gate proof voltages, and can be applied to various semiconductor integrated circuits including MOS type devices, such as a logic LSI, mixed LSI, system, LSI, and memory.

According to the examples of the present invention, the thin-film type MOS transistor can effectively be protected from the surge by ESD in the semiconductor integrated circuit in which the thick-film type MOS transistor and thin-film type MOS transistor are arranged in a mixed manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A semiconductor integrated circuit comprising:
an inner circuit driven by a single power voltage; and
a first protective circuit which protects the inner circuit from a surge,
wherein the inner circuit includes: a high voltage-proof circuit section constituted of a first MOS transistor; a low voltage-proof circuit section constituted of a second MOS transistor including a gate insulating film thinner than that of the first MOS transistor; and a second protective circuit directly connected to the low voltage-proof circuit section to protect the second MOS transistor from the surge.

2. The semiconductor integrated circuit according to claim 1, wherein the low voltage-proof circuit section is driven by an inner power voltage obtained by stepping down the single power voltage.

3. The semiconductor integrated circuit according to claim 2, wherein the second MOS transistor is a device which directly receives the inner power voltage.

4. The semiconductor integrated circuit according to claim 2, wherein the second MOS transistor is a device which directly receives data from the high voltage-proof circuit section.

5. The semiconductor integrated circuit according to claim 1, wherein the low voltage-proof circuit section exchanges data with respect to the high voltage-proof circuit section.

6. The semiconductor integrated circuit according to claim 1, wherein the second protective circuit is constituted of a diode or a diode-connected MOS transistor, and a clamp voltage by the diode or the diode-connected MOS transistor is larger than a maximum value of a voltage range at the time of a usual operation in the low voltage-proof circuit section.

7. A semiconductor integrated circuit comprising:
a high voltage-proof circuit section constituted of a first MOS transistor and driven by a single power voltage; and
a first protective circuit which protects the high voltage-proof circuit section from a surge,
wherein the high voltage-proof circuit section includes: a low voltage-proof circuit section constituted of a second MOS transistor including a gate insulating film thinner than that of the first MOS transistor; and a second protective circuit directly connected to the low voltage-proof circuit section to protect the second MOS transistor from the surge.

8. The semiconductor integrated circuit according to claim 7, wherein the low voltage-proof circuit section is driven by an inner power voltage obtained by stepping down the single power voltage.

9. The semiconductor integrated circuit according to claim 8, wherein the second MOS transistor is a device which directly receives the inner power voltage.

10. The semiconductor integrated circuit according to claim 8, wherein the second MOS transistor is a device which directly receives data from the high voltage-proof circuit section.

11. The semiconductor integrated circuit according to claim 7, wherein the low voltage-proof circuit section exchanges data with respect to the high voltage-proof circuit section.

12. The semiconductor integrated circuit according to claim 7, wherein the second protective circuit is constituted of a diode or a diode-connected MOS transistor, and a clamp voltage by the diode or the diode-connected MOS transistor is larger than a maximum value of a voltage range at the time of a usual operation in the low voltage-proof circuit section.

13. A semiconductor integrated circuit comprising:
a first inner circuit constituted of a first MOS transistor and driven by a first power voltage;
a second inner circuit constituted of a second MOS transistor including a gate insulating film thinner than that of the first MOS transistor and driven by a second power voltage lower than the first power voltage to exchange data with respect to the first inner circuit;
a first protective circuit directly connected to the first inner circuit to protect the first MOS transistor from a surge; and
a second protective circuit directly connected to the second inner circuit to protect the second MOS transistor from the surge.

14. The semiconductor integrated circuit according to claim 13, wherein the second MOS transistor is a device which directly receives the second power voltage.

15. The semiconductor integrated circuit according to claim 13, wherein the second MOS transistor is a device which directly participates in the exchange of the data.

16. The semiconductor integrated circuit according to claim 13, wherein the second protective circuit is directly connected to the second MOS transistor.

17. The semiconductor integrated circuit according to claim 13, wherein the second protective circuit is constituted of a resistance and a capacitor, and has a specific time constant, and the time constant is smaller than a transition time of a signal.

18. The semiconductor integrated circuit according to claim 13, wherein the second protective circuit is constituted of a diode or a diode-connected MOS transistor, and a clamp voltage by the diode or the diode-connected MOS transistor is larger than a maximum value of a voltage range at the time of a usual operation in the second inner circuit.

19. The semiconductor integrated circuit according to claim 13, wherein the second protective circuit is constituted of an analog switch.

20. The semiconductor integrated circuit according to claim 13, wherein the first protective circuit is directly connected to an external terminal, and the second protective circuit is not directly connected to the external terminal.
